(19) United States
(12) Patent Application Publication
(10) Pub. No.: US 2008/0027878 A1
(43) Pub. Date: Jan. 31, 2008

(54) SYSTEMS AND METHODS FOR ESTABLISHING A SPACE PLANNING NETWORK

(75) Inventors: Steve Street, Londonderry, NH (US); Evan Karatzas, Madbury, NH (US); Dave Fullam, Londonderry, NH (US)

Correspondence Address: GROSSMAN, TUCKER, PERREAULT & PFLEGER, PLLC, 55 SOUTH COMMERICAL STREET, MANCHESTER, NH, 03101, US

(73) Assignee: HOOKUMU INCORPORATED, Londonderry, NH (US)

(21) Appl. No.: 11/747,332

(22) Filed: May 11, 2007

Related U.S. Application Data
(60) Provisional application No. 60/747,125, filed on May 12, 2006.

(51) Int. Cl. H04L 9/00; H04K 1/00; G06F 17/50

(52) U.S. Cl. 705/78; 703/1

(57) ABSTRACT

A virtual space planning network may connect third party suppliers of goods and/or services with consumers via a virtual space planning tool. The virtual space planning tool may be used by the consumers to generate and/or interact with a virtual space plan. The virtual space planning network may connect a wide range of end-users (i.e., consumers) and third party product and/or service suppliers to provide a business opportunity. In particular, the virtual space planning network may allow third party suppliers to advertise their products and/or services and/or to generate lead data for their products and/or services. Observational logic may be used to build a database of user behavioral characteristics, advise the user and dynamically recommend complimentary products and/or services.

### CROSS-REFERENCE TO RELATED APPLICATIONS

This application claims the benefit of co-pending U.S. Provisional Patent Application Ser. No. 60/747,125, filed on May 12, 2006, which is fully incorporated herein by reference.

### TECHNICAL FIELD

The present invention relates to networks for initiating opportunities between buyers and sellers and more particularly, to a system and method for establishing a space planning network that initiates opportunities between consumers using a virtual space planning tool and suppliers of products and/or services.

### BACKGROUND INFORMATION

On-line, on-demand space planning tools are available for users to generate a virtual space plan using icons representing various items to be included in the space. One example is the on-line room planner tool available from Icovia®. The existing space planning tools may be launched by consumers from the stores and/or websites of retailers and manufacturers who supply products that may be used in the planned space or by end users who need to generate floor plans for themselves (i.e., homeowners) or for others (i.e., interior designers). Consumers may use the tools to design plans by positioning icons representing products or items into a representation of the space (i.e., a virtual space). The icons may represent products available from the retailer or manufacturer providing the space planning tool as well as other generic products or items that may be used in the space. The consumers may then save, email and/or print the plans for use in purchasing the products for the planned space either on line or at the store.

Such on-line space planning tools offer retailers and manufacturers a way to market products and initiate sales opportunities. The retailers and manufacturers that provide the space planning tool may access the plans generated by consumers, the products selected by the consumer, and other consumer data (e.g., contact information) that may be captured by the space planning tool. Space planning tools may also be integrated with a product catalog (e.g., the specific stock keeping units (SKUs)) for the retailer or manufacturer providing the space planning tool. In addition to an icon for the product, the space planning tool may also display a photo of the product and real-time product data from a product database of the retailer or manufacturer. When icons associated with actual products are placed in the virtual space, the icons may be set to the actual product dimensions.

On-line space planning tools are also available for use in connection with real estate properties for sale or rent. A realtor, for example, may provide the tool on its web site, and prospective buyers may use the tool to plan the space within a particular property listing. The space planning tool may thus be used to initiate an opportunity for a potential real estate transaction.

Although these existing space planning tools may initiate sales opportunities for the retailer or manufacturer providing the space planning tool on its web site, these tools are used to generate plans unique to a particular retailer or manufacturer using products unique to that particular retailer or manufacturer. These existing space planning tools do not allow a user to select from actual products offered by different retailers or manufactures for placement in a single plan. These existing space planning tools also do not allow a user to design a plan using the planning tool on one retailer's web site and then open the same plan using the planning tool on another retailer's web site.

### BRIEF DESCRIPTION OF THE DRAWINGS

These and other features and advantages will be better understood by reading the following detailed description, taken together with the drawings wherein:

FIG. 1 is a diagrammatic view of a virtual space planning network, consistent with one embodiment of the present invention.

FIG. 2 is a diagrammatic view of a virtual space planning system coupled to a distributed computing network, consistent with one embodiment of the present invention.

FIGS. 3 and 4 are screen shots generated by a virtual space planning system, consistent with one embodiment of the present invention.

FIG. 5 is a functional block diagram illustrating a virtual space planning system, consistent with one embodiment of the present invention.

FIG. 6 is a flow chart illustrating a method of establishing a virtual space planning network, consistent with one embodiment of the present invention.

FIG. 7 is a flow chart illustrating a computer implemented method of establishing a virtual space planning network, consistent with another embodiment of the present invention.

FIG. 8 is a flow chart illustrating a method of establishing a virtual space planning network, consistent with yet another embodiment of the present invention.

FIG. 9 is a flow chart illustrating a method of establishing a virtual space planning network for generating advertising fees, consistent with yet another embodiment of the present invention.

FIG. 10 is a flow chart illustrating a method of establishing a virtual space planning network for generating lead data, consistent with yet another embodiment of the present invention.

FIG. 11 is a flow chart illustrating one method of virtual space planning using observational logic.

FIG. 12 is a screen shot generated by a virtual space planning system for use in the context of real estate, consistent with another embodiment of the present invention.

### DETAILED DESCRIPTION

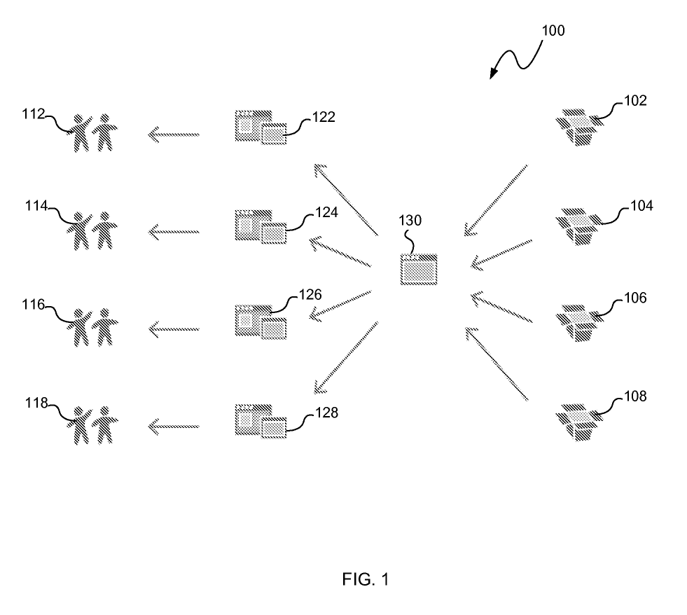

Referring to FIG. 1, a virtual space planning network 100 may connect a plurality of third party suppliers 102, 104, 106, 108 of goods and/or services with consumers 112, 114, 116, 118 via web sites 122, 124, 126, 128 that provide access to an online virtual space planning tool 130. The third party suppliers may provide access to the online space planning tool 130 or may offer products and/or services to consumers through the network without providing access to the online space planning tool 130 (e.g., by listing products and/or services to be displayed to users within an online space planning tool used on other web sites). The virtual space planning tool 130 may be used by the consumers 112, 114, 116, 118 to generate and/or interact with a virtual space plan. The virtual space planning network 100 may connect a wide range of end-users (i.e., consumers) and third party product and/or service providers to provide a business opportunity. In particular, the virtual space planning network 100 may allow third party suppliers 102, 104, 106, 108 to advertise their products and/or services and/or to generate lead data for their products and/or services.

The virtual space planning network 100 may be established in various contexts including, but not limited to, real estate. In the context of real estate, the third party suppliers 102, 104, 106, 108 may include any company providing products or services that consumers would find valuable in the course of designing, renovating, building, selling, purchasing or renting property (e.g., furniture products, home entertainment products, home fixtures, flooring materials, building products, real estate products, architectural services, building services, interior design and decorating services, moving services, and utility providers). The consumers 112, 114, 116, 118 may include home owners, business owners, individuals searching for residential/commercial homes and/or properties for purchase or rental, or individuals interested in purchasing existing floor plans. The web sites 122, 124, 126, 128 that provide access to the online virtual space planning tool 130 may include web sites hosted by, for example, floor plan providers (e.g., houseplans.com), architects, builders, interior designers and decorators, measuring service providers (e.g., Obeo®) that provide space measurement services to real estate firms, marketing agencies that provide traditional and online marketing services to real estate firms, real estate professionals, homeowner information providers (e.g., HGTV®), home improvement retailers (e.g., Home Depot®), and other web search engine or content providers (e.g., Yahoo®, Google®). In this context, the on-line space planning tool 130 may be an on-line floor planning tool similar to the type available under the name ICOVIA®. Those skilled in the art will recognize that a virtual space planning network may be established in other contexts and for the benefit of other types of consumers, third party suppliers and web site providers.

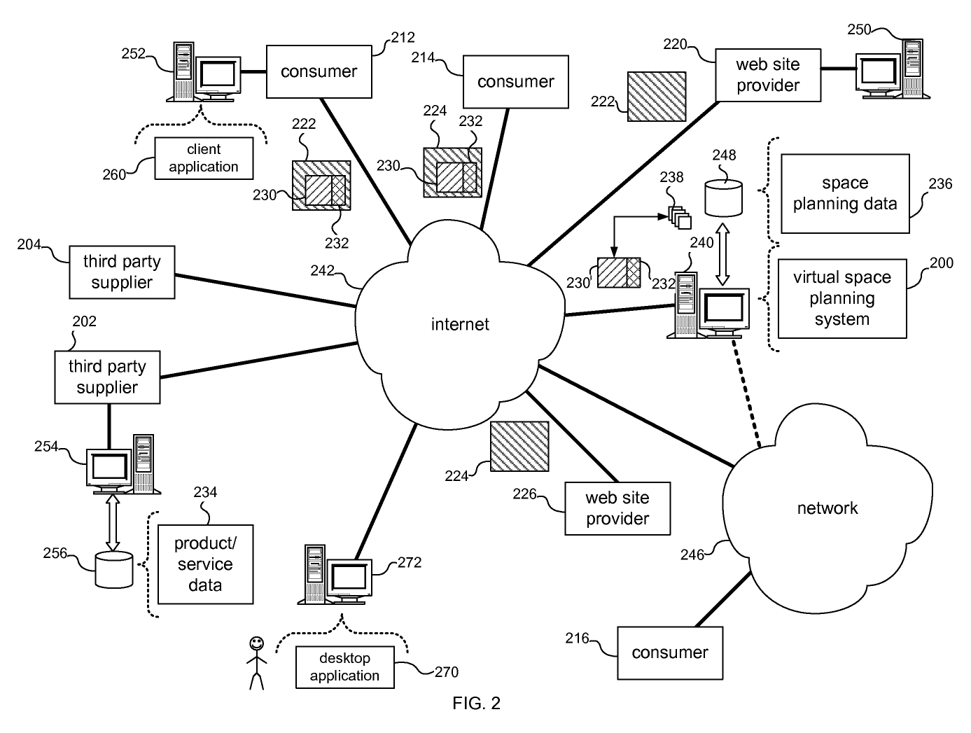

Referring to FIG. 2, a virtual space planning system 200 may be used to establish a virtual space planning network to provide a business opportunity between third party suppliers 202, 204 and users or consumers 212, 214, 216. The virtual space planning system 200 may provide a virtual space planning tool 230 and may recommend products and/or services 232 that are available from different third party suppliers 202, 204. The recommended product/services 232 may be based on product/service data 234 maintained by a third party supplier 202. The consumers 212, 214, 216 may access the virtual space planning tool 230 and recommended products and/or services 232 via one or more web sites 222, 224 hosted by web site providers 220, 226.

The space planning tool 230 may be used to generate one or more space plans 238, for example, by loading existing space plans or creating new space plans. The space plans 238 may be accessed via any of the web sites 222, 224 that provide access to the space planning tool 230 and by any of the customers 212, 214, 216 having authorization to access the plans 238. The virtual space planning system 200 may recommend products and/or services 232 that are relevant to the space plans 238 being generated by the virtual space planning tool 230. In connection with generating space plans 238 using the virtual space planning tool 230 and recommending products and/or services 232, the virtual space planning system 200 may also collect and store space planning data 236, such as user data, space plan data, product/service data, lead data, observational data, and advertising transaction data, as will be described in greater detail below.

The virtual space planning system 200 may reside on and may be executed by a computer 240 that is connected to network 242 (e.g., the Internet). Computer 240 may be a web server running a network operating system, such as Microsoft Windows XP Server™, Novell Netware™, or Redhat Linux™ . Computer 240 may also execute a web server application, such as Microsoft IIS™, Novell Webserver™, or Apache Webserver™, that allows for HTTP (i.e., HyperText Transfer Protocol) access to computer 240 via network 242. The virtual space planning system 200 may also use the Microsoft .NET™ Framework as the overall technology platform. Network 242 may be connected to one or more secondary networks (e.g., network 246), such as a local area network, a wide area network, or an intranet.

The instruction sets and subroutines of the virtual space planning system 200 may be stored on a storage device (e.g., a storage device 248 coupled to computer 240) and may be executed by one or more processors (not shown) and one or more memory architectures (not shown) incorporated into computer 240. Space planning data 236 generated by and/or used by the virtual space planning system 200 may also be stored on a storage device (e.g., storage device 248 coupled to computer 240). The storage device may be, for example, a hard disk drive, a tape drive, an optical drive, a RAID array, a random access memory (RAM), or a read-only memory (ROM). A relational database management system (not shown), such as Microsoft SQL Server 2005, may be used to manage the space planning data 236.

An Application Service Provider (ASP) may host one or more application components of the virtual space planning system 200 and the space planning data 236. The ASP may thus handle application support and storage of data such as usernames, passwords, and customer space plans. The ASP may also handle reporting of certain space planning data such as new registered users and contact information (e.g., email addresses), plans saved, and the most popular aspects (e.g., rooms) of the plans. One of the web site providers 220, 226 may also host the virtual space planning system 200 and the space planning data 236.

All or a portion of the virtual space planning system 200 may also reside on and/or be executed other computers such as web site provider computers 250, consumer computers 252 and/or third party supplier computers 254. At least a portion of the virtual space planning tool 230, for example, may be executed on the consumer computers 252, for example, as an Active XTM control, a Java™ Applet, or a Adobe™ Flash file, as the consumer uses the planning tool 230. All or a portion of the space planning data 236 may also be stored on other storage devices, for example, coupled to web site provider computers 250, consumer computers 252 and/or third party supplier computers 254.

A storage device 256 may also be coupled to a third party supplier computer 254 for storing product and/or service data 234 for the third party supplier 202, for example, in a third party product catalog database. The virtual space planning system 200 may pull real-time product data from a third party product catalog database (e.g., using XML calls) and integrate that product data into the virtual space planning tool 230. Changes to the supplier's catalog may thus be reflected in the space planning tool 230 when the changes are made to the product catalog database. The product and/or service data 234 may also be stored with the space planning data 236 on the storage device 248 (e.g., hosted by an ASP).

Consumers 212, 214, 216 may access the virtual space planning system 200 (e.g., to use the virtual space planning tool 230) directly through network 242 or through secondary network (e.g., network 246). The computer 240 (i.e., the computer that executes the virtual space planning system 200) may be connected to network 240 through a secondary network (e.g., network 246). Consumers 212, 214, 216 may access the virtual space planning system 200 through a computer (e.g., computer 252) that is connected to network 242 (or network 246) and executes a desktop application 260 (e.g., Microsoft Internet Explorer®, Netscape Navigator®, or a specialized interface). The computer 252 may be the consumer's PC or MAC® computer or may be a computer terminal located at a store of a third party supplier or web site provider.

An administrator may access and administer the virtual space planning system 200 through a desktop application 270 (e.g., Microsoft Internet Explorer®, Netscape Navigator®, or a specialized interface) running on an administrative computer 272 that is also connected to the network 242 (or network 246). The administrative computer 272 may be located at the same location as the virtual space planning system 200 or remotely.

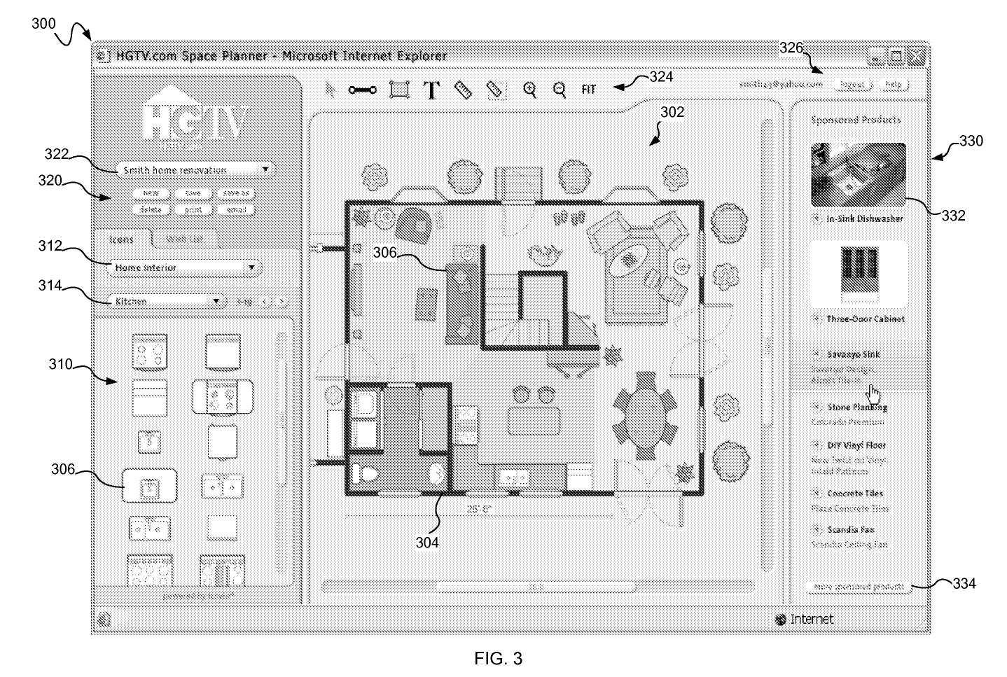

When a user or consumer 212, 214, 216 uses a client application 260 to access or interact with the virtual space planning system 200 and uses the virtual space planning tool 230, the user may be presented with a virtual space planning screen 300, for example, as shown in FIGS. 3 and 4, rendered by the client application 260. Where the client application 260 is a web browser, for example, the virtual space planning screen 300 may be rendered as a web page in the web browser. The virtual space planning web page may be accessed via the web site (e.g., web site 222 shown in FIG. 1) of a web site provider, and the web site provider's logo and/or web address may be included in the screen 300. The virtual space planning screen 300 allows the user to interact with the virtual space planning tool to generate one or more virtual space plans 302. The virtual space plans 302 may be generated as new plans or may be generated by loading existing space plans. Although the exemplary embodiment shows a floor plan for a home, space plans may also include floor plans for other types of buildings (e.g., offices, hotels, convention centers, public buildings), vehicles, and other spaces such as gardens, landscaping areas, public spaces, and recreational areas. Floor plans may also represent views of spaces from a viewpoint other than top-down (e.g., elevation views of spaces including walls and other structural objects, products, window treatments and lighting specifications may be represented).

The virtual space plan 302 may include a space representation 304 of the fixed structures in the space being planned and product icons 306 representing the products to be positioned within the space representation 304. Metadata may be associated with elements of the space representation 304 and/or with the product icons 306, for example, to describe attributes of space represented and/or the product represented. In the exemplary embodiment, the representation 304 includes walls, doors, windows and other structures in the house. The space representation 304 may be a predefined generic representation of a space or a custom designed representation of a space. The user may change the dimensions, locations and configurations of the representation 304, for example, by clicking and dragging the structural items. The user may also change the location and dimensions of the product icons 306, for example, by clicking and dragging the icons.

The virtual space planning screen 300 may also include a group 310 of generic product icons 306 (e.g., displayed in an icon selection panel) that may be selected and placed within the virtual space plan 302, for example, by clicking and dragging the product icons 306 from the selection panel into the space plan 302. The user may select the types of product icons 306 to be displayed in the group 310, for example, using one or more drop down menus 312, 314. For example, the product icons 306 may be organized according to space categories such as broad categories (e.g., home interior) and more specific room categories (e.g., kitchen). The icons 306 displayed in the group 310 may also depend on the nature of the space plan 302, the current icons 306 already in the space plan 302, and user activity and/or information. The icons 306 displayed in the group 310 may change as the user generates the space plan 302, for example, when the user zooms in on different rooms and as the user places icons in the plan.

The virtual space planning screen 300 may also include plan action buttons or links 320 that allow the user to initiate an action such as, for example, save a plan, open a new plan, delete a plan, print a plan or email a plan. A title may be associated with the plans and may be displayed, for example, in a drop down menu 322 that allows the user to select other plans by the plan titles. A registered user who is logged in, for example, may select and display any stored plan that this associated with that user. The virtual space planning screen 300 may also include tool icons 324 that allow the user to initiate various planning tools or functions such as selection tools, text tools, measuring tools, zoom in and out tools, fit to screen tools, and other tools that allow the user to manipulate the virtual space plan 302. The virtual space planning screen 300 may also include a button or link 326 that allows users (e.g., registered users) to log in or log out.

The virtual space planning screen 300 may further include sponsored products 330 recommended to the user (e.g., displayed in a product recommendation panel). The sponsored products 330 may be associated with products represented by icons 306 already placed in the plan 302 or may be added to the plan 302 as icons. The sponsored products 330 that are displayed may be products of third party suppliers who may pay (e.g., advertising fees) to have the products displayed. The third party suppliers may be different than the web site provider that provides access to the virtual space planning tool. In the illustrated example, the virtual space planning tool is accessed via the HGTV.com web site and the sponsored products may be products available from various retailers and/or manufacturers who are not otherwise affiliated with HGTV.

The sponsored products 330 may be recommended based on the plan 302, the icons 306 in the plan 302, the third party supplier (e.g., the sponsorship level or tier), and/or information associated with and/or captured from the user, as will be described in greater detail below. The sponsored products 330 may be displayed with a hierarchy or rank that is based on a sponsorship level or tier of third party agreement. For example, third party suppliers may pay additional fees to display sponsored products at the top of the list. Third party suppliers may also pay additional fees to display photos 332 or other information in addition to a title or name identifying the product. The third party products may also be displayed based on a combination of sponsorship level, relevance to user specified information and/or user specific information derived through observational logic, as described in greater detail below. The space planning screen 300 may also include a button 334 to initiate the display of additional sponsored products. The sponsored products 330 displayed in the recommendation panel may also change as the user generates the virtual space plan 302, for example, using observational logic, as will be described in greater detail below.

By selecting one of the sponsored products 330, the user may be presented with options such as (a) place a product on the floor plan, (b) be linked to product-specific details on a third party web site, or (c) display a product detail screen 400 including additional details about the product, as shown in FIG. 4. The product details may include one or more product images 402, a product description 404, product dimensions 406, a price 408 and/or a stock keeping unit (SKU) 410 associated with the product. The product detail screen 400 may also include one or more buttons 420, 422, 424, 426 to initiate one or more actions with respect to the displayed product. An “Add to Wish List” button 420 may cause the product to be added to a wish list associated with the user or consumer, which may then be accessed later by the user or by others to purchase the product. An “Add to Cart” button 422 may cause the product to be associated with a shopping cart associated with the user to allow the user to purchase the product, for example, after the user is finished with the space planning tool. A “Place in Room” button 424 may cause the product to be positioned within the virtual space plan 302. A “Show Similar” button 426 may cause other similar products to be displayed. The similar products may be products that have been previously identified as similar and associated with the displayed product.

Although certain furniture products and other household products are shown, any other type of relevant product may be displayed in the virtual space planning screen 300. For example, the virtual space planning screen 300 may include lighting, home electronics or other electrical products, appliances, framed artwork to be displayed on walls, gym equipment, shelving systems, closet storage systems, workshop equipment, and/or garage products and hardware. For designing a garden or landscaping, the recommended products may include plants, trees, pathways, walls, fences, sprinkler systems, playground equipment, pools, patio furniture, gardening tools, and other such products. Applications for landscape design also include the online space planner's unique ability to quickly calculate the square footage of areas which can be used to recommend quantities of certain area- or volume-based products like grass seed, loam, pavement, carpeting, tile flooring, and wood flooring.

Although the illustrated embodiment shows sponsored products, the virtual space planning screen 300 may also include sponsored services recommended to the user (e.g., in the recommendation panel). The virtual space planning screen 300 may include, for example, a name of the service and the service provider displayed in a panel (e.g., either the same panel as the products or a separate “Sponsored Service” panel). The sponsored services may be selected in a manner similar to the products described above, for example, to obtain more information about the services or to purchase the services. The services may also be services of third party suppliers that are recommended based on the plan 302, the icons 306 in the plan 302, and information associated with and/or captured from the user. For a floor plan of a house, for example, the recommended services may include mortgage, financing or banking services, landscaping services, home inspection services, housecleaning services, telephone and utilities, moving services, home repair and renovation services, consumer electronics and home theater installation services, and other such services. The virtual space planning screen 300 may essentially display any sponsored products and/or services of third parties that a user of the space planning tool may be interested in purchasing. The products and/or services do not necessarily need to be displayed graphically.

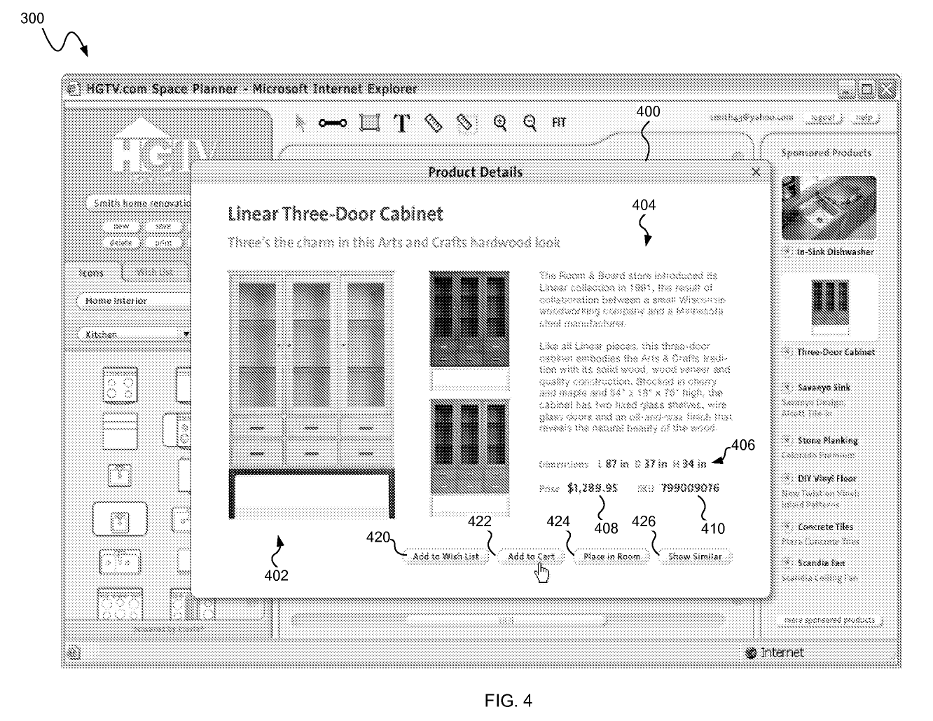

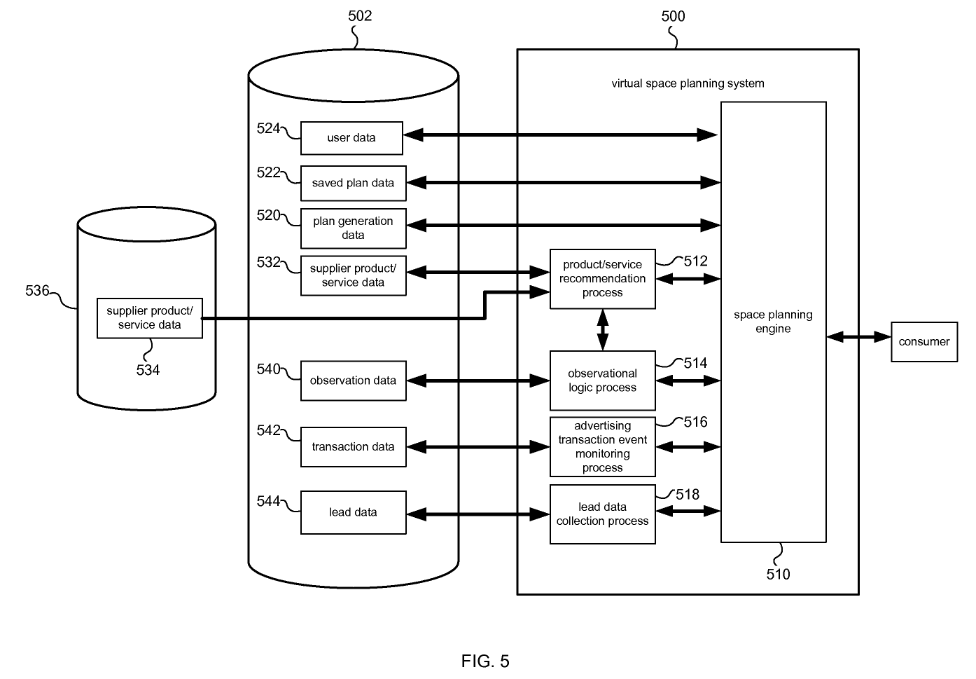

Referring to FIG. 5, embodiments of a virtual space planning system 500 and space planning data 502 are described in greater detail. The space planning system 500 may include a space planning engine 510 that provides the core functionality such as the functions of the space planning tool presented to the user or consumer. The space planning engine 510 may be similar to the engine used in the existing space planning tool available under the name ICOVIA®. The space planning engine 510 may retrieve plan generation data 530 used to generate a virtual space plan. Plan generation data 520 may include, for example, data used to generate space representations 304 and icons 306 (see FIG. 3) as well as metadata associated with the space representations 304 and/or icons 306. The plan generation data 520 may be in the form of one or more files (e.g., icon files).

The space planning engine 510 may load existing space plans from saved plan data 522 and may store generated space plans as saved plan data 522. The space plans may be stored, for example, in a file format that may be opened by space planning tools hosted on other web sites. The space plans may also be stored in other common formats including, but not limited to, pdf, tiff, gif, and jpg. The space planning engine 510 may also store user data 524 such as data associated with registered users and/or data obtained from unregistered users who log in to use the system.

The space planning system 500 may also include a product/service recommendation process 512 that interacts with the space planning engine 510 to recommend relevant products and/or services to the consumer in connection with the virtual space planning tool. The product/service recommendation process 512 may retrieve supplier product/service data 532, 534 for relevant products or services to be recommended and provides that data to the space planning engine 510 for display with the space plan. Product/service data 532 for third party suppliers may be stored with the space planning data 502 and may include the data used to generate the product/service representations (e.g., icons and photos) and product/service details displayed with the space plan being generated (e.g., in a recommendation panel). Product/service data 532 may also include metadata defining other characteristics of the products/services such as categories that may be used to search and/or filter the products/services.

Product/service data 534 for a particular third party supplier may also be stored in a third party supplier database 536 (e.g., a catalog database) and provided directly from the third party supplier to the virtual space planning system 500. The product/service recommendation process 512 may recommend relevant products based on plan information as well as user information and actions, as will be described in greater detail below. When a user selects a new or existing floor plan for a home, for example, the product/service recommendation process 512 may retrieve supplier product/service data 532, 534 for furniture products that may be suitable for the selected floor plan or that have already been associated with the selected floor plan.

The space planning system 500 may also include an observational logic process 514 that interacts with the space planning engine 510 and the product/service recommendation process 512 to refine the recommendations based on observational logic. The observational logic process 514 captures actions taken by the user and information provided by the user when using the virtual space planning tool to generate a space plan. Such actions may include, for example, placing product icons into the plan and constructing and/or navigating the space plan (e.g., moving from room to room). In response to the captured actions and information, the observational logic process 514 may determine a particular category or type of product and/or service. The product/service recommendation process 512 may then recommend products/services for this particular category or type.

Product/service data 532, for example, may include data associating the products and/or services with the categories that may be determined by the observational logic in response to the user actions and information. In one example, categories or types may be based on product types (e.g., sinks), room types (e.g., bathroom), cost (e.g., luxury products), sponsorship or advertising level, third party suppliers, product lines, and most frequently viewed or selected products/services. For example, observational logic may be used to infer a user's needs and product/service interests based on icons appearing most frequently in a plan or within the users defined viewing space (i.e., area of the plan user is focusing on) and/or based on icon category selection, icon selection, etc. Those skilled in the art will recognize that various other categories associated with products and/or services may be determined by the observational logic in response to user actions and/or information.

If an icon for a product with a particular product type is placed, for example, the observational logic process 514 may determine that products associated with that product category should be recommended. According to another example, if a particular room is being viewed, the observational logic process 514 may determine that products associated with that type of a room should be recommended. According to a further example, if the user has entered information or taken an action (e.g., by placing products) indicating that the space being planned may be a “luxury property,” the observational logic process 514 may determine that products associated with that “luxury” category should be recommended. According to yet another example, if a product belonging to a particular product line is placed, the observational logic process 514 may determine that products associated with that product line category should be recommended. According to yet another example, the observational logic process 514 may determine complimentary products (e.g., based on icons in a plan) and may determine products to be recommended based on whether or not the complimentary product icons are absent from the plan. If a sofa appears in a living space, for example, but an ottoman is absent, one or more ottomans may be recommended.

In addition to or instead of refining the product/service recommendations, the observational logic process 514 may also be used to refine how recommended products/services are displayed to the user. The top level products displayed in a recommendation panel, for example, may be the products within a category determined by the observational logic process 514. Such top level products may include additional information such as photos of the products.

The observational logic process 514 may also store observation data 540 that logs the information and actions taken by the user and/or a category that has been determined by the observational logic process 514. The observation data 540 may be stored for a plurality of users of a space planning network. The observation data 540 may be indexed according to the individual users, all users and/or subgroups of users (e.g., users with a particular income level). The observation data 540 for a particular user or for a group of users may then be used by the observational logic process 514 at a later time when the user is generating a virtual space plan. The observational logic process 514, for example, may capture user actions and/or information and determine if such captured user actions and/or information match or closely match actions and/or information in the observation data 540. Thus, the observational logic is not confined to a single user generating a single plan. By managing a network of users, plans and products, the observational logic may programmatically analyze patterns and trends throughout a network, which may be used to make dynamic product recommendations. Observation data may indicate, for example, that a number of users who place an icon of a refrigerator in a plan also click through to a certain category of food preparation appliance. When a user later places a refrigerator (i.e., a matching scenario), such observation data may be used to refine recommendations made to that user, for example, to elevate placement of the food preparation appliance products.

The space planning system 500 may also include an advertising transaction event monitoring process 516 that interacts with the space planning engine 510 and monitors events that trigger advertising fees payable by a third party supplier. The advertising transaction events may include a recommendation of a third party product or service, a user selection of a third party product for inclusion in a plan, a user selection of additional details for a product or service, a user “click through” to a web site for the product or service, a user “click through” to product details within the online space planner, a user “click through” to product details on a website, a user saving a plan with the supplier product included in the plan, a user loading a plan including the supplier product, a user adding a supplier product or service to a wish list, and a user purchasing a supplier product or service. Those skilled in the art will recognize that other events associated with potential customers being exposed to supplier products or services may also be used as advertising transaction events.

The advertising transaction event monitoring process 516 may store transaction data 542 indicating the advertising transaction events that have occurred for the different products/services and/or for the different third party suppliers. The transaction data 542 may also include a calculation of the advertising transaction fees owed by a particular third party supplier based on the monitored transactions. The virtual space planning system 500 may support different advertising arrangements or plans. According to one plan, for example, a third party supplier may pay an advertising transaction fee for every occurrence of one or more of the advertising transaction events. According to another plan, third party suppliers may bid on placement of the supplier products/services relative to other supplier products/services (e.g., a higher level placement) and may pay the bid amount upon occurrence of a particular transaction event (e.g., a click through to the product web site). Third party suppliers may also pay advertising fees just to have the products/services listed without requiring any particular advertising transaction event. Those skilled in the art will recognize that other fee arrangements may also be based on advertising transaction events.

The space planning system 500 may also include a lead data collection process 518 that interacts with the space planning engine 510 and collects and stores lead data 544. The lead data 544 may include data associated with users and the products and/or services in which users have expressed interest during the virtual space planning process. When a user selects additional product details or adds a product to a wish list, for example, the lead data 544 may include data identifying those products and data identifying the user.

The lead data 544 may be provided to the third party suppliers of the identified products and/or services, for example, in exchange for a fee. In one embodiment, the virtual space planning system 500 may compile reports using the lead data 544 and make the reports available to the third party suppliers (e.g., by sending an email or allowing a third party to download the report from a web site). The third party may then use the lead data to initiate a potential sale with the potential customer.

The processes 512, 514, 516, 518 may be implemented as software running on one or more processing systems such as one or more general purpose computers. Although the exemplary embodiment of the virtual space planning system 500 includes the processes 512, 514, 516, 518, other embodiments of the virtual space planning system 500 may include any one or more of the processes 512, 514, 516, 518 in combination with the space planning engine 510. Although the processes 512, 514, 516, 518 are represented as discrete processes, these processes 512, 514, 516, 518 may not necessarily operate as separate, discrete processes within the virtual space planning system 500. The virtual space planning system 500 may also include other processes to facilitate the functions and features described herein.

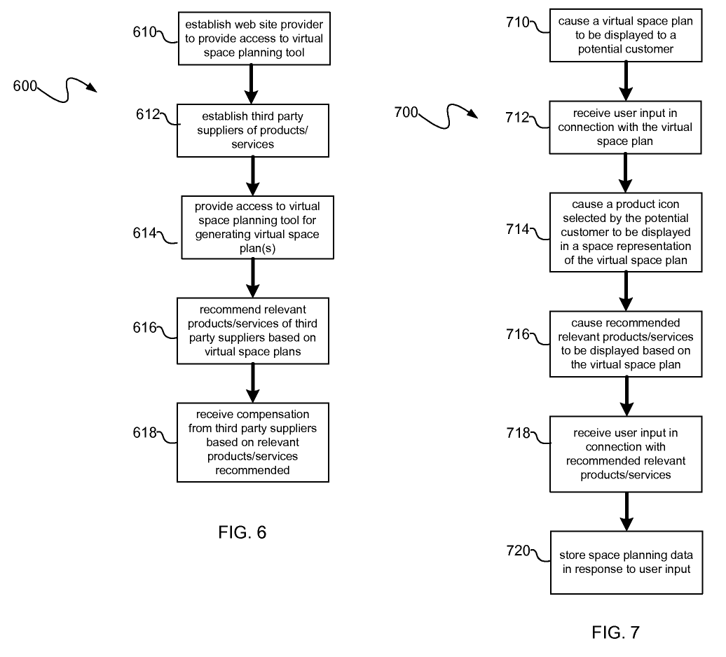

FIG. 6 generally illustrates a method 600 of establishing a virtual space planning network. According to this method, a web site provider is established 610 to provide access to a virtual space planning tool and a plurality of third party suppliers of products and/or services are established 612. As mentioned above, the web site provider may be one of the suppliers of goods and/or services or may be an entity different from the suppliers of goods and/or services. The method also provides access 614 to the virtual space planning tool for generating virtual space plans. Access may be provided, for example, via a web site of the web site provider, which may be accessed by the user or potential customer. Based on the virtual space plans generated using the virtual space planning tool, relevant products and/or services of the third party suppliers are recommended 616 to the user of the space planning tool (i.e., the potential customer). This method further includes receiving 618 compensation from the third party suppliers based on the relevant products and/or services that are recommended. The compensation may be in the form of advertising fees and/or compensation for lead data or observation data that has been collected.

FIG. 7 illustrates a computer-implemented method 700 of establishing a virtual space planning network. This computer-implemented method 700 causes a virtual space plan to be displayed 710 to a potential customer and receives 712 user input in connection with the virtual space plan. As mentioned above, for example, the virtual space plan may include at least one space representation and the user input may be the selection of one or more product icons to be positioned within the space representation. The computer-implemented method may then cause one or more product icons selected by the potential customer to be displayed 714 in the space representation of the virtual space plan. As a result, a virtual space plan is generated.

The computer-implemented method 700 further causes the display 716 of recommended relevant products and/or services of third party suppliers based on the user input received from the potential customer in connection with the virtual space plan and receives 718 user input from the potential customer in connection with the recommended relevant products and/or services. In response to the user input received in connection with the recommended products and/or services displayed to the potential customers, space planning data is stored 720. The space planning data generally includes data representing user actions in connection with the recommended products and/or services, such as advertising transaction data, lead data and/or observation data.

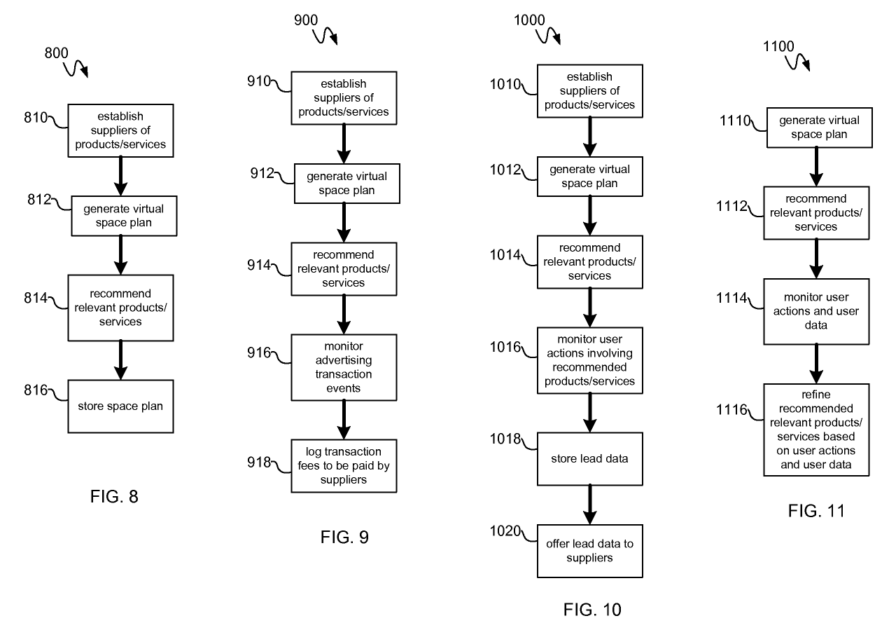

FIGS. 8-11 illustrate additional methods consistent with embodiments of the present invention. According to the exemplary method 800 shown in FIG. 8, third party suppliers of potentially relevant products and/or services are established 810. As mentioned above, the third party suppliers will depend on the type of space and the context in which the space planning tool is used. The third party suppliers may then provide product/service data for the relevant products and/or services that the third party supplier wants to recommend in connection with the virtual space planning tool. The third party suppliers may pay fees to have their products and/or services recommended with the virtual space planning tool. The fees may be subscription fees, advertising fees and/or fees for lead data.

A virtual space planning tool may then be used to generate 812 one or more virtual space plans. As described above, a virtual space plan may be generated by loading an existing space plan or by generating a new virtual space plan. Existing space plans may be saved plans previously associated with that user or associated with other users who have elected to share the saved plans. The virtual space plan that is generated may be associated with user data for a particular user, for example, if the user is logged in or registered. Existing space plans may also be generic plans predefined by another entity (e.g., by a web site provider or by a third party supplier). An existing plan in a CAD or design web format (DWF) used by an architect, plan provider or builder, for example, may be rendered into a format compatible with the virtual space planning tool and stored for access by the users.

As the virtual space plan is generated, products and/or services relevant to the virtual space plan that is being generated may be recommended 814 to the user. The products and/or services may be recommended by displaying representations (e.g., icons, images, titles or other information) of the products and/or services in a recommendation panel. The relevancy of the products and/or services may be determined, for example, based on the type of space plan and the icons placed in the plan. For existing space plans, the relevancy of the products and/or services may be predetermined, for example, by the user or entity that originally created the space plan. The user may select one or more of the recommended products and/or services, for example, to obtain additional details, to place the product in the plan, to purchase the product or service, to add the product or service to a wish list, or to click through to the web site for the product or service.

After the plan has been generated, the virtual space plan may be stored 816. The virtual space plan may be stored as a file in a file format readable by the virtual space planning tool. The virtual space plan may also be stored in other file formats (e.g., pdf, jpg, tif, gif) that may be readable by other file viewers. Virtual space plans may be stored in a common database that may be accessed when using the space planning tool from any web site providing access to the space planning tool. The virtual space plans may also be accessed simultaneously by multiple users, for example, to allow real-time collaboration by multiple users working on the same space plan. The virtual space plan may be stored together with recommended products and/or services, user data, and/or observation data associated with the particular space plan.

Referring to FIG. 9, one method 900 of establishing a virtual space planning network for advertising is illustrated. Similar to the method shown in FIG. 8, this method 900 establishes 910 third party suppliers of potentially relevant products and/or services, generates 912 one or more virtual space plans using a virtual space planning tool, and recommends 914 products and/or services relevant to the virtual space plan being generated. According to this method, the third party suppliers may elect to participate in various advertising plans under which the third party supplier pays advertising transaction fees for any of a variety of different advertising transaction events that may occur relative to the recommended products and/or services. Advertising transaction events may include, for example, displaying a recommended product or service, providing additional details for a product or service, adding a product or service to a plan, saving a plan with a recommended product or service associated therewith, adding a product or service to a wish list, purchasing a product or service or clicking through to a web site for the product or service.

As the virtual space plan is being generated and/or the recommended products and/or services are reviewed, the advertising transaction events are monitored 916 and may be logged. As the advertising transaction events occur, the advertising fees payable by the third party suppliers are logged 918. The third party supplier may then be billed or otherwise notified of the fees that are owed. The fees may be fixed fees that the third party supplier agrees to pay per certain specified transaction events. The fees may also be based on bids made by the third party suppliers. Third party suppliers may bid, for example, for a particular high level placement of the product. Those skilled in the art will recognize that various fee arrangements may be based on advertising transaction events.

Referring to FIG. 10, one method 1000 of establishing a virtual space planning network for lead generation is illustrated. Similar to the method shown in FIG. 8, this method 1000 establishes 1010 third party suppliers of potentially relevant products and/or services, generates 1012 one or more virtual space plans using a virtual space planning tool, and recommends 1014 products and/or services relevant to the virtual space plan being generated. As relevant products and/or services are recommended, user actions involving the relevant products and/or services are monitored 916. Such user actions may include, for example, a request for additional details, adding a product or service to a plan, adding a product to a wish list, loading a plan with a product placed therein, or saving a plan with a product placed therein.

As user actions involving recommended products and/or services are monitored, lead data associated with those products and/or services may be stored 1018. The lead data may include user data (e.g., user contact information), product/service data (e.g., SKU associated with the product), third party supplier data (e.g., the name of the supplier of the product), and data identifying the nature of the lead (e.g., additional details displayed). Lead data may be captured through actions, such as saving, emailing and printing plans, and may be acquired through direct query to the user. In the real estate context, for example, the user may enter contact info and may answer questions in response to the general query “are you interested in viewing this property?”

The lead data may then be offered 1020 to third party suppliers, for example, to be purchased by the third party suppliers. The lead data may be in the form of a report made available to the third party suppliers, for example, by email or by a link on a web site. The third party suppliers may purchase lead data instead of or in addition to paying advertising fees. Fees for lead data may depend upon the level of information provided. Lead data may also be provided free of charge to third party suppliers who agree to pay a certain level of advertising transaction fees or a subscription fee. Lead data may also be provided or sold to the web site provider hosting the online space planning tool. Fees or commissions may also be paid to the web site providers based on lead data that is generated by the online space planning tool hosted by that web site and sold to a third party.

Referring to FIG. 11, one method 1100 of virtual space planning using observational logic is illustrated. According to this method 1100, a virtual space plan is generated 1110 and products and/or services relevant to the virtual space plan are recommended 1112 in connection with the virtual space plan (e.g., product representations are displayed in a recommendation panel with the space plan). The relevant products and/or services may be products and/or services of different third party suppliers, for example, as described above. Alternatively, the relevant products and/or services may be the products and/or services of a single retailer or manufacturer who is providing access to a virtual space planning tool via its web site. The initial products and/or services that are recommended may be products and/or services that have already been associated with a saved plan or a generic/default plan that is being loaded.

As the space plan is generated and relevant products and/or services are recommended, user data and actions are monitored 1114 and may be captured. The user data may include, for example, data entered by the user about the space (e.g., square footage, location) and/or data about the user (e.g., income levels, existing property). The user actions may include actions in selecting, constructing and/or navigating the space plan, such as placing generic icons or recommended product icons into the space or zooming in on a particular section of the space.

The recommended products and/or services may then be refined 1116 based on the user data and actions. The recommendations of products and/or services may be refined by displaying different products and/or services in response to the user data and actions. In one embodiment, observational logic may be used to refine product/service recommendations in response to user data and/or actions. The observational logic may determine one or more categories of products and/or services associated with certain user data and/or actions. Categories may then be used to filter recommended products and/or services displayed to the user.

If a user zooms into a bedroom portion of a home floor plan, for example, the product recommendation panel may intelligently respond with products from this category. If the user places generic icons or recommended product icons in a virtual space plan, complimentary products may be recommended. If a specific pedestal sink is placed in a bathroom, for example, toilets that work well with that product may be recommended. If the user selects a floor plan for a home with a large square footage and indicates that the home is a waterfront home, “luxury” products may be recommended. Those skilled in the art will recognize various types of categories and various ways in which observational logic may be used to refine product and/or service recommendations.

This method may be used with the advertising method or lead data method described above. Observational logic may be used to recommend products and/or services that are more relevant to the user and/or plan being generated, which results in more targeted advertising and more reliable lead data. Observational logic may also allow products and/or services of some third party suppliers to be recommended to certain categories of users and/or plans. Some third party suppliers, for example, may only want to pay an advertising fee to recommend products for use in “luxury” plans.

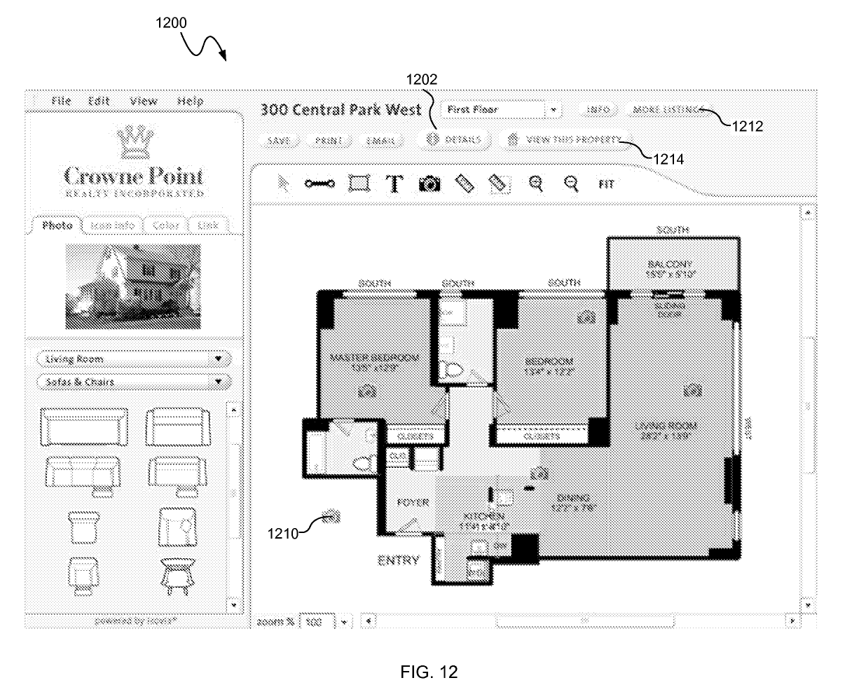

FIG. 12 shows another embodiment of a virtual space planning screen 1200 for use in the real estate context, which may be rendered when a user 212, 214, 216 uses the client application 260 to access a virtual space planning system 200 and the virtual space planning tool 230 (see FIG. 2). The virtual space planning screen 1200 may include a space representation, icons, and other features similar to the virtual space planning screen 300 shown in FIG. 3 and described above. The virtual space planning screen 1200 may also include icons, action buttons and/or links to request additional real estate information. For example, a user may view photos of the actual property by clicking on camera icons 1210 and may obtain additional details by clicking on a “DETAILS” button 1202. The user may review other listings associated with the realtor presenting the property by using a “MORE LISTINGS” button 1212. The user may also make an appointment to see the actual property using a “VIEW THIS PROPERTY” button 1214. In response to clicking on the “VIEW THIS PROPERTY” button 1214, additional information may be requested from the user (e.g., contact information). Such additional information may be used to generate lead data that may be sold to the company hosting the space planning tool or to other third parties, as described above.

Accordingly, the virtual space planning systems and methods described herein may be used to establish a virtual space planning network between potential customers, web site providers and third party suppliers. The network advantageously allows the customers to view a variety of different third party supplier products and/or services related to a virtual space plan being generated. The network advantageously allows the third party suppliers to market and advertise products and/or services to a wider range of potential customers and to obtain valuable lead data for customers who are interested in the products and/or services. The network advantageously allows the web site providers to increase traffic to their web sites by offering a valuable space planning tool with information on third party supplier products and/or services.

Embodiments of the methods described above may be implemented as software or a computer program product for use with a processing system or computer. Such implementation may include, without limitation, a series of computer instructions that embody all or part of the functionality described herein. The series of computer instructions may be stored in any machine-readable medium, such as semiconductor, magnetic, optical or other memory devices, and may be transmitted using any communications technology, such as optical, infrared, microwave, or other transmission technologies. Such a computer program product may be distributed as a removable machine-readable medium (e.g., a diskette, CD-ROM), preloaded with a computer system (e.g., on system ROM or fixed disk), or distributed from a server or electronic bulletin board over the network (e.g., the Internet or World Wide Web). Alternative embodiments of the invention may be implemented as pre-programmed hardware elements or as a combination of hardware, software and/or firmware.

Those skilled in the art will recognize that this is one possible implementation of the functionality described herein. A virtual space planning system may also include other processes in addition to or in place of the processes described herein. These processes may be executed by a processor on one computer or may be executed by processes on separate computers. Space planning data may include other types of data in addition to or in place of the data described herein.

Consistent with one embodiment, a method is provided for establishing a virtual space planning network. The method includes establishing a web site provider to provide access to a virtual space planning tool; establishing a plurality of third party suppliers of products and/or services to be recommended to potential customers; providing the potential customers with access to the virtual space planning tool for use in generating at least one virtual space plan, the virtual space planning tool being accessed via a web site hosted by the web site provider; recommending relevant products and/or services of at least some of the third party suppliers to the potential customers using the virtual space planning tool based on virtual space plans generated by the virtual space planning tool; and receiving compensation from the third party suppliers based on the relevant products and/or services recommended to the potential customers using the virtual space planning tool.

Consistent with another embodiment, a computer-implemented method is provided for establishing a virtual space planning network between potential customers and third party suppliers of products/services to be used in connection with a space being planned. The computer-implemented method includes causing a virtual space plan to be displayed to at least one potential customer, the virtual space plan including at least a space representation; receiving user input from the at least one potential customer in connection with the virtual space plan, the user input including at least a selection of a product icon to be positioned within the space representation; causing the product icon to be displayed within the space representation in response to the user input; causing recommended relevant products and/or services of a plurality of third party suppliers to be displayed to the potential customer based on at least the user input from the potential customer in connection with the virtual space plan, wherein the recommended relevant products and/or services are selectable by the potential customer; receiving user input from the potential customer in connection with the recommended relevant products and/or services of the third party suppliers; and storing space planning data in response to at least the user input in connection with the recommended products and/or services displayed to the potential customer, said space planning data including data representing user actions relative to the recommended relevant products and/or services. A machine-readable medium may include instructions stored thereon, which perform this computer-implemented method when executed by a processing system.

Consistent with a further embodiment, a computer-implemented virtual space planning system is provided for establishing a space planning network. The system includes a space planning engine configured to generate virtual space plans; a product/service recommendation process configured to recommend products and/or services based on the virtual space plans generated by the space planning engine; and an observational logic process configured to capture user actions and information relative to the virtual space plans, to compare the user actions and information to observation data, and to cause the product/service recommendation process to recommend products and/or services based on the user actions and information.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A method for establishing a virtual space planning network, comprising:
establishing a web site provider to provide access to a virtual space planning tool;
establishing a plurality of third party suppliers of products and/or services to be recommended to potential customers;
providing the potential customers with access to the virtual space planning tool for use in generating at least one virtual space plan, the virtual space planning tool being accessed via a web site hosted by the web site provider;
recommending relevant products and/or services of at least some of the third party suppliers to the potential customers using the virtual space planning tool based on virtual space plans generated by the virtual space planning tool; and
receiving compensation from the third party suppliers based on the relevant products and/or services recommended to the potential customers using the virtual space planning tool.

2. The method of claim 1 wherein the web site provider is different than the third party suppliers.

3. The method of claim 1 wherein the compensation includes advertising fees.

4. The method of claim 1 wherein the advertising fees are based on advertising transaction events relative to the products and/or services recommended to the potential customers using the virtual space planning tool.

5. The method of claim 1 wherein the compensation includes fees paid for lead data generated by the virtual space planning tool.

6. The method of claim 1 wherein the relevant products and/or services are recommended based on observational logic.

7. The method of claim 1 wherein the virtual space plan includes a plan for a house.

8. A computer-implemented method for establishing a virtual space planning network between potential customers and third party suppliers of products/services to be used in connection with a space being planned, the method comprising:
causing a virtual space plan to be displayed to at least one potential customer, the virtual space plan including at least a space representation;
receiving user input from the at least one potential customer in connection with the virtual space plan, the user input including at least a selection of a product icon to be positioned within the space representation;
causing the product icon to be displayed within the space representation in response to the user input;
causing recommended relevant products and/or services of a plurality of third party suppliers to be displayed to the potential customer based on at least the user input from the potential customer in connection with the virtual space plan, wherein the recommended relevant products and/or services are selectable by the potential customer;
receiving user input from the potential customer in connection with the recommended relevant products and/or services of the third party suppliers; and
storing space planning data in response to at least the user input in connection with the recommended products and/or services displayed to the potential customer, said space planning data including data representing user actions relative to the recommended relevant products and/or services.

9. The method of claim 8 wherein the user input in connection with the recommended products and/or services includes a request to purchase at least one of the recommended relevant products and/or services from the third party suppliers.

10. The method of claim 8 wherein the recommended relevant products and/or services include sponsored products associated with product icons selected by the potential customer for positioning within the space representation.

11. The method of claim 8 wherein the recommended relevant products and/or services are recommended based on at least the product icons positioned within the space representation.

12. The method of claim 8 wherein the recommended relevant products and/or services are displayed with a rank based on at least a sponsorship level of the third party suppliers of the recommended relevant products and/or services.

13. The method of claim 12 wherein the rank of the recommended relevant products and/or services is also based on user input in connection with the virtual space plan.

14. The method of claim 8 further comprising monitoring advertising transaction events involving the recommended products and/or services, and wherein storing the space planning data includes logging at least advertising transaction fees to be paid by the third party suppliers based on the advertising transaction events.

15. The method of claim 8 wherein the space planning data includes lead data associated with the potential customer based on the user actions of the potential customer involving the recommended products and/or services.

16. The method of claim 8 wherein the space planning data includes observation data, advertising transaction data, lead data or a combination thereof.

17. The method of claim 8 further comprising dynamically refining the recommended relevant products and/or services to be displayed using observational logic in response to user input.

18. The method of claim 8 wherein the user input includes user data identifying characteristics of the potential customer and the user input relative to the virtual space plan.

19. The method of claim 18 further comprising comparing the user input to observation data and dynamically refining the recommended relevant products and/or services to be displayed based on the comparison between the user input and the observation data.

20. The method of claim 8 wherein causing the virtual space plan to be displayed includes causing the virtual space plan to be displayed via a web site of a web site provider, and further comprising storing the virtual space plan such that the virtual space plan is accessible from another web site of another web site provider.

21. The method of claim 8 wherein causing the virtual space plan to be displayed includes loading an existing virtual space plan that has been stored by the potential customer.

22. The method of claim 8 wherein causing the recommended relevant products and/or services of third party suppliers to be displayed includes displaying a name of the relevant products and/or services and a name identifying the third party suppliers.

23. The method of claim 8 wherein receiving user input in connection with the recommended relevant products and/or services includes receiving user input selecting at least one of the recommended relevant products and/or services, and further comprising causing additional details to be displayed about the selected at least one of the recommended relevant products and/or services.

24. The method of claim 8 wherein the virtual space plan includes a plan for a house, the plan including a representation of an interior space including at least one room.

25. A machine-readable medium whose contents cause a computer system to perform the method of claim 8.

26. A machine-readable medium whose contents cause a computer system to perform the method of claim 14.

27. A machine-readable medium whose contents cause a computer system to perform the method of claim 17.

28. A computer-implemented virtual space planning system for establishing a space planning network, the system comprising:
a space planning engine configured to generate virtual space plans;
a product/service recommendation process configured to recommend products and/or services based on the virtual space plans generated by the space planning engine; and
an observational logic process configured to capture user actions and information relative to the virtual space plans, to compare the user actions and information to observation data, and to cause the product/service recommendation process to recommend products and/or services based on the user actions and information.

29. The virtual space planning system of claim 28 further comprising an advertising transaction event monitoring process configured to monitor advertising transaction events and to log advertising fees payable to third party suppliers.

30. The virtual space planning system of claim 28 further comprising a lead data collection process configured to collect and store lead data.
